(19) United States
(12) Patent Application Publication
(10) Pub. No.: US 2022/0283770 A1
(43) Pub. Date: Sep. 8, 2022

(54) CONTROL METHOD OF ELECTRONIC DEVICE AND EXTERNAL CONTROL DEVICE

(71) Applicant: CHAMP VISION DISPLAY INC., Miaoli County (TW)

(72) Inventors: Hsin-Mao Chung, MIAO-LI COUNTY (TW); Chun-Chung Hsiao, MIAO-LI COUNTY (TW)

(73) Assignee: CHAMP VISION DISPLAY INC., Miaoli County (TW)

(21) Appl. No.: 17/672,726

(22) Filed: Feb. 16, 2022

(30) Foreign Application Priority Data
Mar. 2, 2021 (CN) 202110230779.6

(51) Int. Cl. G06F 3/14; G06F 3/041

(52) U.S. Cl. CPC G06F 3/1454; G06F 3/0418; G06F 3/1423; G06F 3/041661

(57) ABSTRACT

A control method of an electronic device and an external control device are provided. The control method may control the electronic device through a non-contact method. The external control device includes a handheld electronic device and an arithmetic control device. The external control device obtains display specification information of the electronic device, and the handheld electronic device is adapted for performing an image capturing action on a control interface of the electronic device to obtain a captured image. The handheld electronic device receives touch information. The external control device calculates coordinate conversion information between the captured image and an image of the control interface of the electronic device according to the display specification information and the captured image, converts the touch information to generate converted touch information according to the coordinate conversion information, and executes a control action on the electronic device according to the converted touch information.

### CROSS-REFERENCE TO RELATED APPLICATION

This application claims the priority benefit of China application serial no. 202110230779.6, filed on March 2, 2021. The entirety of the above-mentioned patent application is hereby incorporated by reference herein and made a part of this specification.

### BACKGROUND

### Technical Field

The invention relates to a control method of an electronic device and an external control device, and in particular to a non-contact control method of an electronic device and an external control device for image control.

### Description of Related Art

Self-service systems in public places are increasing in popularity, such as service systems including an automated teller machine (ATM) and a multimedia device in a convenient store, most of which use a touch panel as an input device for a human-machine interface. When users use these self-service systems, they need to touch the touch panels thereof to operate these self-service systems, but the lack of cleanliness of the panels poses potential risks to public health. A touch device is usually integrated on a flat panel display to conform to a human-machine operation mode which facilitates hand-eye coordination. An existing capacitance touch solution may increase a sensing distance by adding capacitance sensing electrical characteristics so as to achieve a non-contact purpose. However, there is still a chance for users to touch the screen during distance control in the actual operation. On the other hand, by using an infrared (IR) optical or ultrasonic sensor module which is installed externally on the display to detect locations of movements of a substance on a screen surface, although an assembly location may be adjusted appropriately to increase a distance between a sensing surface and a display surface, in practice, a disparity generated due to the distance may affect user experience and must be taken into account. In addition, there exist solutions to detect the depth of a substance or recognize gestures, for example, an optical image, a time-of-flight (TOF) sensor, etc. to achieve a long-distance operation. By using the solutions to detect the depth of a substance or recognize gestures, the above-mentioned issues may be avoided; however, a learning curve in usage is high, and in some cases, if personal data need to be input, the personal data might be leaked due to an operation action, so that the solutions are not suitable to be used in public places.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

In view of the above, with regard to the electronic device of the above-mentioned self-service system, the disclosure provides a control method of the electronic device and an external control device, and a control action of the electronic device may be performed through a non-contact method.

Other objectives and advantages of the invention may be further understood from the technical features disclosed in the invention.

In order to achieve one or part or all of the above-mentioned objectives or other objectives, an embodiment of the invention proposes a control method of an electronic device. The control method includes the following. An external control device is paired with the electronic device, and display specification information of the electronic device is obtained. The external control device performs an image capturing action on a control interface of the electronic device to obtain a captured image. Coordinate conversion information between the captured image and an image of the control interface of the electronic device is calculated according to the display specification information and the captured image. The external control device receives touch information, converts the touch information according to the coordinate conversion information to generate converted touch information, and executes a control action on the electronic device through the control interface according to the converted touch information.

In order to achieve one or part or all of the above-mentioned objectives or other objectives, an embodiment of the invention proposes an external control device adapted for control an electronic device. The external control device includes a handheld electronic device and an arithmetic control device. The arithmetic control device is coupled to the handheld electronic device, and is paired with the electronic device to obtain display specification information of the electronic device. The handheld electronic device is adapted for performing an image capturing action on a control interface of the electronic device to obtain a captured image. The handheld control device receives touch information. The external control device calculates coordinate conversion information between the captured image and an image of the control interface of the electronic device according to the display specification information and the captured image. The external control device converts the touch information according to the coordinate conversion information to generate converted touch information, and executes a control action on the electronic device through the control interface according to the converted touch information.

Based on the above, the embodiments of the invention at least have one of the following advantages or efficacies. Firstly, the user controls the electronic device through touching the image captured by the external control device, so the user controls the electronic device without directly touching the control interface of the electronic device. Secondly, leakage of personal data due to an operation action is avoided.

To further describe the features and advantages of the disclosure, embodiments accompanied with drawings are described below in details.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an architecture of an external control device and an electronic device to be controlled by the external control device according to an embodiment of the invention.

FIG. 2 is a schematic view of an operation of an external control device according to an embodiment of the invention.

FIG. 3 is a schematic diagram of a coordinate conversion between an image captured by a handheld electronic device and an image of a control interface of an electronic device according to an embodiment of the invention.

FIG. 4 is a schematic diagram of an image captured by a handheld electronic device according to an embodiment of the invention.

FIG. 5 is a block diagram of a system block of an external control device and an electronic device to be controlled by the external control device according to an embodiment of the invention.

FIG. 6 is a schematic diagram of operating a keystone correction action on a captured image according to an embodiment of the invention.

FIG. 7 is a schematic flow chart of a control method provided by an embodiment of the invention.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The foregoing and other technical contents, features and efficacies of the invention will be clearly presented in the following detailed description of an exemplary embodiment with accompanying drawings. The term “coupling (or connection)” used in the full text of the specification of this application (including the claims) may refer to any direct or indirect connection methods, and the connection may be conducted through a wired or wireless method; a wired communication connection method is, for example, connecting through a universal serial bus (USB); a wireless communication connection method is, for example, communicating and connecting through methods including the Global System for Mobile communications (GSM), the Worldwide Interoperability for Microwave Access (WiMax), Code Division Multiple Access (CDMA), Near Field Communication (NFC), Bluetooth or Wi-Fi.

Hereinafter, various embodiments of the invention will be described in detail through the accompanying drawings. However, the concept of the invention may be embodied in many different forms, and should not be interpreted as being limited to the exemplary embodiment set forth herein. In addition, same reference numerals may be used to refer to like elements in the drawings.

Referring to FIG. 1, FIG. 1 is a schematic diagram of an external control device according to an embodiment of the invention. An external control device 4 is coupled to an electronic device 3 for controlling the electronic device 3. The external control device 4 includes a handheld electronic device 1 and an arithmetic control device 2. In this embodiment, the arithmetic control device 2 is coupled between the handheld electronic device 1 and the electronic device 3. The handheld electronic device 1 may be a handheld electronic device such as a smart phone, a tablet computer, or a notebook computer. The electronic device 3 may be, for example, an automated teller machine, a multimedia device in a convenient store, etc. The arithmetic control device 2 may be a USB Dongle, WIFI Dongle, a Near-field communication (NFC) Dongle, a IR (Infrared) Dongle, or a Bluetooth Dongle. In this embodiment, the arithmetic control device 2 may be pre-disposed to the outside of the electronic device 3; alternatively, when a user wants to use the electronic device 3, the user then allows the arithmetic control device 2 to be coupled to the electronic device 3, and the invention is not limited thereto.

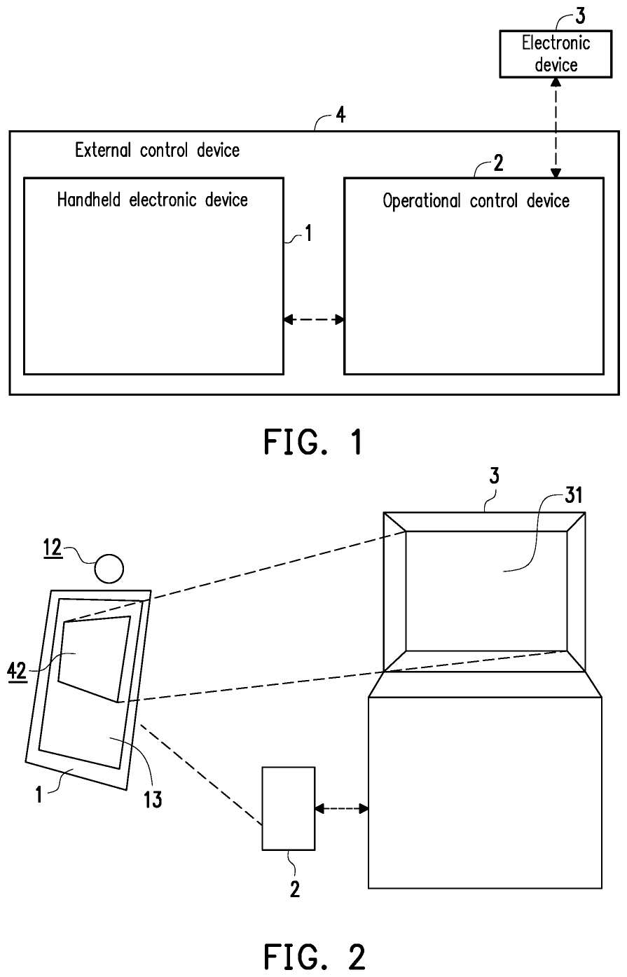

Referring to FIG. 2, FIG. 2 is a schematic view of an operation of the external control device according to an embodiment of the invention. In this embodiment, when a control action is to be performed on the electronic device 3, the external control device 4 may be paired with the electronic device 3 through the arithmetic control device 2. Moreover, after the pairing action is finished, the user may use an image capturing device 12 of the external control device 4 to perform an image capturing action on the control interface of the electronic device 3 to obtain a captured image 42. In this embodiment, the user may perform an image capturing action on the touch screen (a control interface 31) of the electronic device 3 to obtain the captured image 42 including the touch screen.

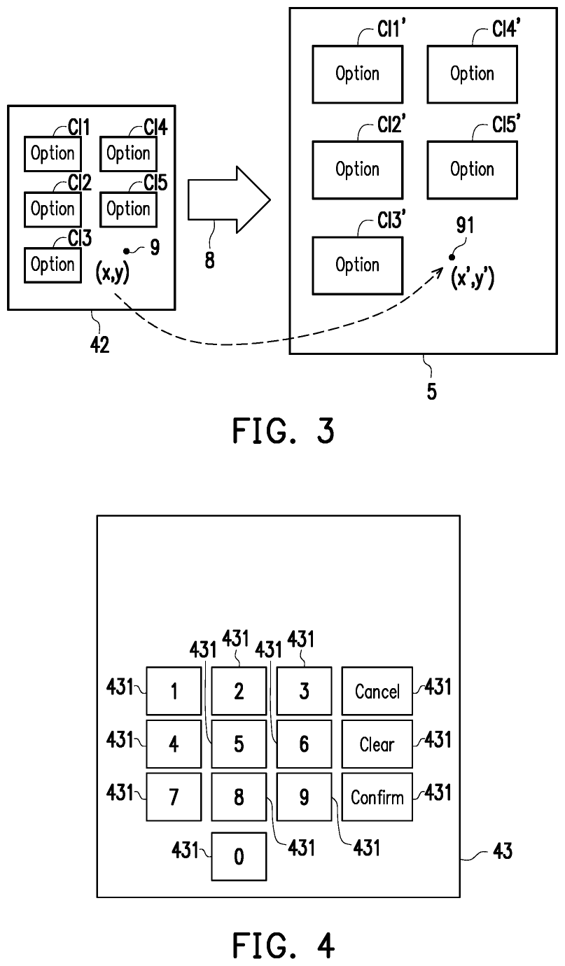

Referring to FIGS. 2 and 3 together, FIG. 3 is a schematic diagram of a coordinate conversion between an image captured by the handheld electronic device and an image of the control interface of the electronic device according to an embodiment of the invention. Since the size and image resolution of the captured image mentioned above are usually not the same as the size and image resolution of the touch screen (the control interface 31) of the electronic device 3, the external control device 4 may calculate coordinate conversion information 8 between the captured image 42 and an image 5 of the control interface 31 of the electronic device 3 through the handheld electronic device 1 or the arithmetic control device 2. In this embodiment, the external control device 4 may obtain the coordinate conversion information 8 according to the display specification information of the electronic device 3 and the captured image 42. The display specification information of the electronic device 3 may be provided by the electronic device 3 to the external control device 4 after the pairing action of the external control device 4 and the electronic device 3 is finished, and the display specification information includes the image resolution of the control interface of the electronic device 3.

Next, the user may execute a touch control through the captured image 42 corresponding to the image 5 of the control interface 31 of the electronic device 3 displayed on the handheld electronic device 1. The external control device 4 receives the touch information generated by the user's touch control, and converts the touch information according to the coordinate conversion information 8 to generate a converted touch information. This converted touch information may be delivered to the electronic device 3, and a control action may be executed on the electronic device 3 through the control interface 31 of the electronic device 3.

It is to be noted that regarding operation details, the handheld electronic device 1 may display a reference frame, and the user may perform an image capturing action on the control interface of the electronic device 3 according to the reference frame to obtain the captured image 42.

In addition, the external control device 4 may execute a keystone correction action on a captured image. In this embodiment, the external control device 4 may apply a keystone correction method well known to those of ordinary skill in the art to execute a keystone correction action on the captured image, and the invention is not limited in this respect. FIG. 6 and the description in the following related paragraphs may be referred to for a further description of using the keystone correction technology.

In addition, according to the image resolution of the control interface 31 of the electronic device 3, the external control device 4 may calculate the size of the control interface 31 of the electronic device 3. The above-mentioned calculation may be completed by the handheld electronic device 1 or the arithmetic control device 2, and the invention is not limited thereto.

Next, when the user executes a touch action on the touch screen (the touch display panel 13) of the handheld electronic device 1 to generate touch information, the handheld electronic device 1 receives the touch information through the touch display panel 13. The touch information may be touch coordinates (x, y) of a user touch point 9, and the external control device 4 may execute a coordinate conversion action on the touch information according to the coordinate conversion information 8 to obtain converted touch information.

This converted touch information corresponds to the location of a corresponding touch point 91 of the control interface of the electronic device 3. This location has report point information of converted touch coordinates (x′, y′). The external control device 4 may obtain the data transmit format or the standard protocol of the electronic device 3 through a pairing action with the electronic device 3, so that the report point information conforms to the data transmit format or the standard protocol of the control interface 31 of the electronic device 3. The converted touch information is delivered to the control interface 31 of the electronic device 3. Since the converted touch coordinates have the data transmit format or the standard protocol of the control interface 31 of the electronic device 3, a touch event corresponding to the control interface 31 may be generated according to the converted touch coordinates (x′, y′). As shown in FIG. 3, after the coordinate conversion, options C11 to C15in the captured image 42 respectively correspond to options C11′ to C15′ in the image 5 of the control interface 31 of the electronic device 3. Therefore, when the user executes a touch control through the captured image 42 corresponding to the electronic device 3 displayed on the handheld electronic device 1, the user executes a control action corresponding to the options C11′-C15′ on the electronic device 3 through selecting any of the options C11 to C15 in the captured image 42 in FIG. 3.

In an embodiment of the invention, the handheld electronic device 1 may scan a graphic code provided by the electronic device 3 and displayed on the control interface 31 to obtain the above-mentioned pairing information. The graphic code may be a general one-dimensional barcode, a two-dimensional barcode, a quick response code (QR code) or any other form of image that may record information, and the invention is not limited thereto. After the handheld electronic device 1 obtains the pairing information, the handheld electronic device 1 delivers the pairing information to the arithmetic control device 2 to finish the pairing action of the arithmetic control device 2 and the electronic device 3. Furthermore, the arithmetic control device 2 may obtain the display specification information of the paired electronic device 3. It should be noted that in addition to being displayed on the control interface 31, the graphic code may be displayed or recorded on any location of the electronic device 3, as long as the graphic code may be scanned by the user with the handheld electronic device 1, and the invention is not limited thereto.

In an embodiment of the invention, the handheld electronic device 1 may obtain the above-mentioned pairing information through a short-distance communication mechanism. Next, the handheld electronic device 1 may deliver the pairing information to the arithmetic control device 2 to finish the pairing of the arithmetic control device 2 and the electronic device 3. The pairing of the arithmetic control device 2 and the electronic device 3 may allow the arithmetic control device 2 to obtain the display specification information of the electronic device 3. The short-distance communication mechanism may be Near-field communication (NFC) or Bluetooth, etc., and the invention is not limited thereto.

Referring to FIG. 4, FIG. 4 is a schematic diagram of the image captured by the handheld electronic device according to an embodiment of the invention. After the pairing action is finished and the user uses the image capturing device 12 of the external control device 4 to perform the image capturing action on the control interface 31 of the electronic device 3 to obtain a captured image 43, the handheld electronic device 1 may directly perform an image recognition on the captured image 43 to recognize a plurality of characteristic signs 431 on the captured image 43. The characteristic sign 431 may be a key containing a digit from 0 to 9 or a combination thereof, or a key containing a word such as “Cancel”, “Clear”, and “Confirm”, or a key containing a word in other languages, and the key may contain any symbol that may be recognized.

When the user executes the touch control through the captured image 43 corresponding to the electronic device 3 displayed on the handheld electronic device 1, the handheld electronic device 1 determines the characteristic sign 431 touched by the user according to the user touch point to generate touch information. The external control device 4 receives the touch information generated by the user's touch control. The arithmetic control device 2 may generate a control code according to the characteristic sign 431 corresponding to the touch information. The arithmetic control device 2 directly executes a corresponding control action on the electronic device 3 according to the control code.

It is to be noted that the arithmetic control device 2 may use the control code alone to execute the corresponding control action on the electronic device 3 or use the technology of generating the touch event corresponding to the control interface 31 according to the converted touch coordinates (x′, y′) as described above. Of course, the above two may both be used for a more precise or convenient operation, and the invention is not limited thereto.

In an embodiment of the invention, after the pairing action of the external control device 4 and the electronic device 3 is finished, the user may perform an image capturing action on a physical keyboard of the electronic device 3 through the image capturing device 12 of the external control device 4 to obtain the captured image 43 of the physical keyboard. The handheld electronic device 1 may directly perform an image recognition on the captured image 43 of the physical keyboard to recognize the plurality of characteristic signs 431 on the captured image 43.

When the user executes a touch control through the captured image 43 of the physical keyboard displayed on the handheld electronic device 1, the handheld electronic device 1 determines the characteristic sign 431 touched by the user according to the user touch point to generate touch information. The external control device 4 receives the touch information generated by the user's touch control. The arithmetic control device 2 generates a control code according to the characteristic sign 431 corresponding to the touch information. The arithmetic control device 2 directly executes a corresponding control action on the electronic device 3 according to the control code. Taking the electronic device 3 as an ATM as an example, the control code generated by the arithmetic control device 2 according to the characteristic sign 431 corresponding to the touch information may be a keyboard scan code. The arithmetic control device 2 delivers the generated keyboard scan code to the electronic device 3, and generates an effect which is equivalent to the effect of pressing a key on the physical keyboard of the electronic device 3, and the control of the electronic device 3 is thus finished.

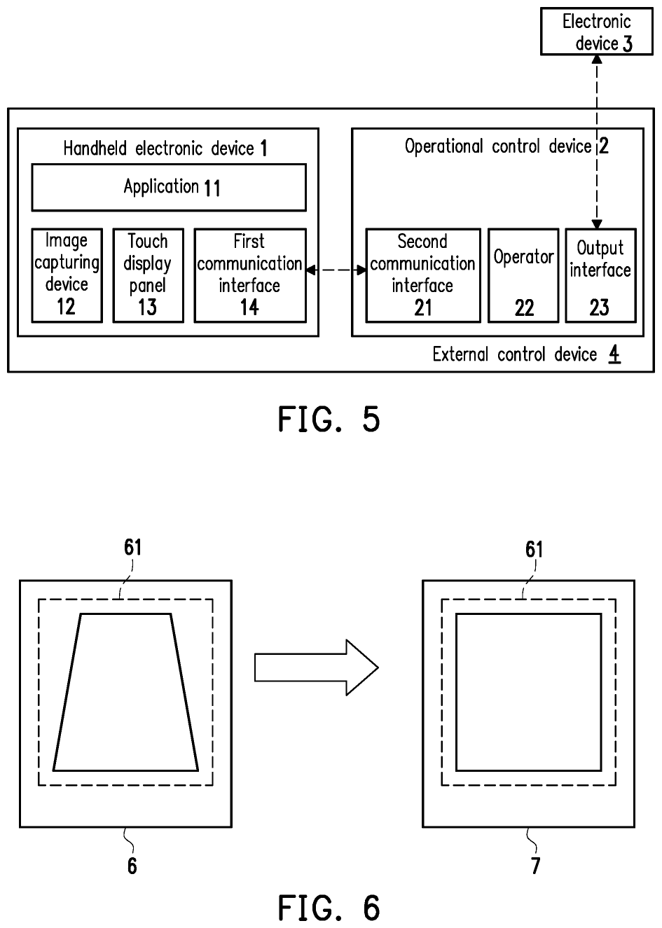

Referring to FIG. 5, FIG. 5 is a block diagram of a system block of the external control device and the electronic device to be controlled by the external control device according to an embodiment of the invention. In this embodiment, the handheld electronic device 1 includes a first communication interface 14 and the image capturing device 12. The first communication interface 14 is coupled to the arithmetic control device 2. The image capturing device 12 is coupled to the first communication interface 14. The image capturing device 12 is configured to obtain a captured image. The handheld electronic device 1 further includes a touch display panel 13 to receive the user's touch information through the touch display panel 13.

On the other hand, in this embodiment, the arithmetic control device 2 includes a second communication interface 21. The second communication interface 21 is wired to or is wirelessly coupled to the first communication interface 14. The arithmetic control device 2 further includes an processor 22. The processor 22 is coupled to the second communication interface 21 and may be configured to calculate the coordinate conversion information 8. The processor 22 may convert the user's touch information according to the coordinate conversion information 8 to generate converted touch information. The arithmetic control device 2 further includes an output interface 23. The output interface 23 is coupled to the electronic device 3. The output interface 23 is configured to deliver the converted touch information to the electronic device 3.

In this embodiment, the handheld electronic device 1 integrates apparatuses including the touch display panel 13, the image capturing device 12 and the first communication interface 14 through an application 11 to execute the control action on the electronic device 3.

Referring to FIGS. 2 and 6 together, FIG. 6 is a schematic diagram of operating a keystone correction action on the captured image 42 according to an embodiment of the invention. As shown in FIG. 6, although the control interface 31 of the electronic device 3 or the options C11 to C15in the control interface 31 are generally rectangular, after the user uses the image capturing device 12 to capture an image through the handheld electronic device 1 by referring to a reference frame 61 displayed on the touch display panel 13, sometimes a substance that should have been rectangular in a captured image 6 becomes a trapezoidal shape due to factors such as the user's shooting angle or hardware limitation.

The above phenomenon may affect the accuracy of the coordinate conversion information 8 between the captured image 42 and the image 5 of the control interface 31. To solve this problem, a keystone correction technology may be used. An effective range of the actual captured image 6 is calculated, for example, by referring to the frame 61. A keystone correction parameter of the captured image is calculated according to the effective range. Next, the keystone correction parameter is used to correct the actual captured image 6 to obtain an expected image 7. Therefore, in an embodiment of the invention, the handheld electronic device 1 may further use an image processing technology to calculate the effective range of the actual captured image 6. Next, the handheld electronic device 1 calculates the keystone correction parameter of the captured image according to the effective range and the keystone correction technology. Finally, the handheld electronic device 1 executes the keystone correction action on the actual captured image 6 according to the keystone correction parameter to obtain the expected image 7.

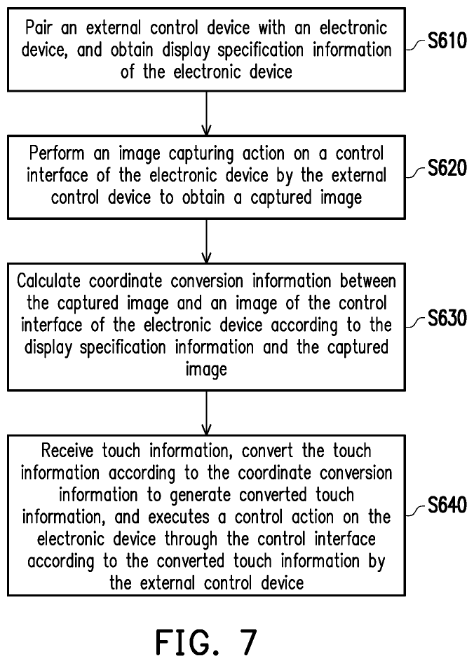

Referring to FIG. 7, FIG. 7 is a schematic flow chart of a control method provided by an embodiment of the invention. In step S610, an external control device is paired with an electronic device, and display specification information of the electronic device is obtained; in step S620, an image capturing action is performed on a control interface of the electronic device by the external control device to obtain a captured image; in step S630, coordinate conversion information between the captured image and an image of the control interface of the electronic device is calculated according to the display specification information and the captured image; in step S640, touch information is received, the touch information is converted according to the coordinate conversion information to generate converted touch information, and a control action is executed on the electronic device through the control interface according to the converted touch information by the external control device.

The implementation details of the above steps have been described in detail in the foregoing embodiments, and will not be repeated herein.

In summary, the embodiments of the invention at least have one of the following advantages or efficacies. Firstly, the user controls the electronic device through touching the image captured by the external control device, so the user may control the electronic device without directly touching the control interface of the electronic device and without having to learn other operation methods. Secondly, leakage of personal data due to an operation action may be avoided.

The above content demonstrates exemplary embodiments of the invention, and the scope of the implementation of the invention cannot be limited thereto. That is, all equivalent changes and modifications made in accordance with the claims and specification of the invention still fall within the scope covered in the patent of the invention. In addition, any of the embodiments or claims of the invention does not have to achieve all the objectives or advantages or features disclosed in the invention. In addition, the abstract and title are merely used to facilitate the search of patent documents, and do not limit the scope of the invention. In addition, the terms “first” and “second” mentioned in the specification or claims are only used to name the elements or to distinguish between different embodiments or ranges, and are not used to limit the upper or lower limit of the number of elements.

The foregoing description of the preferred of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the invention is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A control method of an electronic device, comprising:
pairing an external control device with the electronic device, and obtaining display specification information of the electronic device;
performing an image capturing action on a control interface of the electronic device by the external control device to obtain a captured image;
calculating coordinate conversion information between the captured image and an image of the control interface of the electronic device according to the display specification information and the captured image; and
receiving touch information, converting the touch information according to the coordinate conversion information to generate converted touch information, and executing a control action on the electronic device through the control interface according to the converted touch information by the external control device.

2. The control method of an electronic device according to claim 1, wherein performing the image capturing action on the control interface of the electronic device by the external control device to obtain the captured image comprises:
calculating an effective range of the captured image;
calculating a keystone correction parameter of the captured image according to the effective range; and
executing a keystone correction action on the captured image according to the keystone correction parameter.

3. The control method of an electronic device according to claim 1, wherein pairing the external control device with the electronic device comprises:
scanning a graphic code provided by the electronic device by the external control device, or pairing the external control device with the electronic device through a short-distance communication mechanism.

4. The control method of an electronic device according to claim 1, wherein the display specification information comprises an image resolution of the control interface of the electronic device.

5. The control method of an electronic device according to claim 1, wherein receiving the touch information, converting the touch information according to the coordinate conversion information to generate the converted touch information, and executing the control action on the electronic device through the control interface according to the converted touch information by the external control device comprises:
receiving the touch information by the external control device, wherein the touch information is touch coordinates;
converting the touch coordinates according to the coordinate conversion information to generate converted touch coordinates as the converted touch information; and
executing the control action on the electronic device according to the converted touch coordinates.

6. The control method of an electronic device according to claim 1, further comprising:
recognizing a plurality of characteristic signs on the captured image;
generating a control code according to the characteristic sign corresponding to the touch information; and
executing the control action on the electronic device according to the control code.

7. An external control device, adapted for controlling an electronic device, comprising a handheld electronic device and an arithmetic control device,
wherein the arithmetic control device is coupled to the handheld electronic device, and is paired with the electronic device to obtain display specification information of the electronic device,
wherein: the handheld electronic device is adapted for performing an image capturing action on a control interface of the electronic device to obtain a captured image, and the handheld control device receives touch information; the external control device calculates coordinate conversion information between the captured image and an image of the control interface of the electronic device according to the display specification information and the captured image, converts the touch information according to the coordinate conversion information to generate converted touch information, and executes a control action on the electronic device through the control interface according to the converted touch information.

8. The external control device according to claim 7, wherein the handheld electronic device is further adapted for:
calculating an effective range of the captured image;
calculating a keystone correction parameter of the captured image according to the effective range; and
executing a keystone correction action on the captured image according to the keystone correction parameter.

9. The external control device according to claim 7, wherein the handheld electronic device is paired with the electronic device through scanning a graphic code provided by the electronic device or through a short-distance communication mechanism.

10. The external control device according to claim 7, wherein the display specification information comprises an image resolution of the control interface of the electronic device.

11. The external control device according to claim 7, wherein the handheld electronic device receives the touch information through a touch display panel, wherein: the touch information is touch coordinates; the arithmetic control device or the handheld electronic device converts the touch coordinates according to the coordinate conversion information to generate converted touch coordinates as the converted touch information, and executes the control action on the electronic device according to the converted touch coordinates.

12. The external control device according to claim 7, wherein the handheld electronic device recognizes a plurality of characteristic signs on the captured image, the arithmetic control device generates a control code according to the characteristic sign corresponding to the touch information, and the arithmetic control device executes the control action on the electronic device according to the control code.

13. The external control device according to claim 7, wherein the handheld electronic device comprises a first communication interface and an image capturing device,
wherein the image capturing device is coupled to the first communication interface, and the image capturing device is adapted for obtaining the captured image.

14. The external control device according to claim 13, wherein the arithmetic control device comprises a second communication interface, a processor, and an output interface, wherein,
the second communication interface is wired to or wirelessly coupled to the first communication interface;
the processor is coupled to the second communication interface, and is adapted for calculating the coordinate conversion information and converting the touch information according to the coordinate conversion information to generate the converted touch information; and
the output interface is coupled to the electronic device and delivers the converted touch information to the electronic device.

15. The external control device according to claim 7, wherein the handheld electronic device executes the control action on the electronic device through an application.
